(19) United States
(12) Patent Application Publication
(10) Pub. No.: US 2005/0265161 A1
(43) Pub. Date: Dec. 1, 2005

(54) Method of reproducing multimedia data using musicphotovideo profiles and reproducing apparatus using the method

(75) Inventors: Jin-yong Ahn, Suwon-si (KR); Seong-kook Shin, Seoul (KR); Du-il Kim, Suwon-si (KR); Young-yoon Kim, Seoul (KR); Hee-yeon Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/135,301

(22) Filed: May 24, 2005

(30) Foreign Application Priority Data
May 25, 2004 (KR) 10-2004-0037257

(51) Int. Cl. G11B 5/09

(52) U.S. Cl. 369/47.1; 369/59.1

(57) ABSTRACT

A method and apparatus for reproducing multimedia data using a MusicPhotoVideo (MPV) profile. The method for reproducing multimedia data using a profile complying with the MPV standard, includes: detecting a reference element indicating that a predetermined profile among a plurality of supported profiles is used, in an MPV document; updating the MPV document using information on a profile corresponding to the detected reference element; and reproducing multimedia data by parsing the updated MPV document. Accordingly, by using the MPV standard profile, multimedia data can be reproduced more efficiently.

### BACKGROUND OF THE INVENTION

This application claims the priority of Korean Patent Application No. 10-2004-0037257, filed on May 25, 2004, in the Korean Intellectual Property Office, the disclosure of which is incorporated herein in its entirety by reference.

1. Field of the Invention

Apparatuses and methods consistent with the present invention relate to reproduction of multimedia data, and more particularly, to a method of reproducing multimedia data using a profile of the MusicPhotoVideo (MPV) standard, and a reproducing apparatus thereof.

2. Description of the Related Art

Digital cameras, digital camcorders, or digital audio reproducing apparatuses supporting an MP3 file, which is an MPEG audio file, and a WMA file, which is a Microsoft Windows Media Audio file, are now widely used. Thus, various kinds of multimedia contents such as video, audio, text, and document data, need to be generated.

Apparatuses generating these multimedia contents can generate metadata, which specifies properties of the generated contents, such as a reproduction sequence or a method of reproducing contents, as well as can generate the multimedia contents. For example, when a photo is taken with a digital camera, metadata defining properties such as a display sequence and display intervals of a plurality of photos, and relations among the plurality of photos, is generated at the same time such that the photos can be reproduced using slide-show or panorama functions.

Multimedia data containing metadata together with contents can be reproduced by personal computers (PC), media servers, and a variety of other multimedia reproducing apparatuses. Also, it can be edited or produced as desired by an author, using a PC or a media server. Accordingly, the user can enjoy produced or edited contents in addition to the original contents using a multimedia reproducing apparatus. Also, multimedia contents can be provided to users through online services.

However, since the interoperability between a multimedia contents generation apparatus and a multimedia reproducing apparatus is weak, metadata is frequently not transferred to the apparatus reproducing the contents. As a result, there is a problem that contents are not reproduced according to the metadata described above. This is because the contents generation apparatus and the contents reproducing apparatus use different data structures and data processing methods.

To solve this problem, the MusicPhotoVideo (MPV) standard is currently being prepared by the Optical Storage Technology Association (OSTA). The MPV standard aims to ease management, playback, and exchange of multimedia data such as digital photos, video, audio, text, and document data, which are stored in a storage medium such as an optical disc, a memory card, and a computer hard disc, or exchanged on the Internet.

FIG. 1 is a diagram explaining the structure of multimedia data complying with the MPV standard.

Referring to FIG. 1, MPV standard multimedia data recorded on a storage medium or transmitted through the Internet includes an MPV manifest file 110 and a contents file 120. In particular, the MPV manifest file 110 is an extensible markup language (XML)-based document to control reproduction of contents according to the metadata described above. The MPV manifest file 110 defines assets that define the list of multimedia data, and metadata that defines properties of multimedia data and is coupled to the assets. Hereinafter, the MPV manifest file 110 will be referred to as an MPV document. The MPV document is reproduced by using a series of profiles according to the media type of the included contents.

FIG. 2 is a diagram explaining a profile structure required for reproducing multimedia data complying with the MPV standard.

Referring to FIG. 2, the MPV standard includes an MPV core (Core) 210 and a profile 200 using the MPV core. The profile includes a basic profile 202, a presentation profile 204, a music profile 206, and a spare profile 208 to be supported and to be included in the MPV standard in the future.

The MPV core 210 is a part defining the list of multimedia data, i.e., assets and includes elements such as a collection, metadata, and an identifier. In particular, the collection includes elements such as a manifest (Manifest), an asset list (AssetList), and marked assets (MarkedAssets). The MPV core 210 and the basic profile 202 define assets.

The presentation profile 204 is a part defining a method of displaying multimedia data on a display screen, and defines the method of displaying multimedia data such as a foreground, a background, and a slide show reproduced together with background music, or audio narration.

The music profile 206 defines metadata such as a music file collection and musicians linked to the collection, years of producing a music file, and online information.

The contents reproducing apparatus determines whether to use the basic profile 202, the presentation profile 204, or the music profile 206, according to the type of MPV elements included in the MPV document 110. That is, in order to efficiently reproduce multimedia contents by using the MPV document, it is not necessary to load all the profiles of the MPV standard shown in FIG. 2 into a memory, and according to the MPV elements included in the MPV document, only appropriate profiles are selectively loaded into the memory and then used.

FIG. 3 is a diagram showing an example of a multimedia data file complying with the MPV standard. Referring to FIGS. 2 and 3, the MPV document 110 includes an asset list (AssetList) 306, which defines the list of multimedia data, and metadata 304 defining properties. In particular, a ProfileBag 304 can be defined in the metadata as property information (file:ManifestProperties) of a manifest file. The ProfileBag 304 is a part defining profiles used in an MPV document.

In a PROFILE-DECLARATION part, the following definition of a profile can be included, if, for example, when the MPV document uses the basic profile 202:
<file:Profile>http://ns.osta.org/mpv/basic/1.0/</file:Profile>

Also, when the MPV document uses the presentation profile 204, the following definitions can be included:
<file:Profile>http://ns.osta.org/mpv/basic/1.0/</file:Profile>
<file:Profile>http://ns.osta.org/mpv/presentation/1.0/</file:Profile>

When the MPV document uses the music profile 206 together with the basic profile 202, the following definitions can be included:
<file:Profile>http://ns.osta.org/mpv/basic/1.0/</file:Profile>
<file:Profile>http://ns.osta.org/mpv/music/1.0/</file:Profile>

When the MPV document uses the music profile 206 together with the presentation profile 204, the following definitions can be included:
<file:Profile>http://ns.osta.org/mpv/basic/1.0/</file:Profile>
<file:Profile>http://ns.osta.org/mpv/presentation/1.0/</file:Profile>
<file:Profile>http://ns.osta.org/mpv/music/1.0/</file:Profile>

It should be noted that the basic profile defining the asset list should be included. Thus, by defining in advance in the front part of the MPV document profiles used according to elements contained in the MPV document, the reproducing apparatus can easily load the required profiles into the memory, by parsing the MPV document when multimedia data is reproduced.

However, in the MPV standard, there is no compulsory rule about the ProfileBag 304 described above. In other words, depending on the specification of an apparatus reproducing an MPV document, the ProfileBag may or may not be included. Accordingly, the multimedia content reproducing apparatus should directly determine a profile used in an MPV document. In addition, there is another problem that for an identical MPV document, the profile used in the document should be determined as described above, whenever the document is reproduced.

Furthermore, even when a ProfileBag is included in an MPV document, whether or not the ProfileBag accurately includes profiles used in the actual MPV document cannot be confirmed.

### SUMMARY OF THE INVENTION

The present invention provides a method for reproducing multimedia data by which profiles used in an MPV file are not determined every time multimedia data is reproduced, and multimedia data is reproduced by efficiently using an MPV standard profile, and a reproducing apparatus thereof.

According to an aspect of the present invention, there is provided a method for reproducing multimedia data using a profile complying with a an MPV standard, including: detecting a reference element indicating that a predetermined profile among a plurality of supported profiles is used, in an MPV document; updating the MPV document using information on a profile corresponding to the detected reference element; and reproducing multimedia data by parsing the updated MPV document.

The plurality of supported profiles may include at least one of a basic profile which defines an asset list, a presentation profile which defines a method of displaying multimedia data, a music profile which defines a music related file, and a spare profile to be supported.

The reference element may be an asset list (AssetList) element in the case of the basic profile, an album (Album) element in the case of the presentation profile, and a music properties (MusicProperties) element or audio+digital photo (AudioWithStill) element in the case of the music profile.

In updating the MPV document, the information on the profile corresponding to the detected reference element may be added to a ProfileBag definition part of the MPV document.

In updating the MPV document, if a reference element is not detected and information on a profile corresponding to a reference element is in the ProfileBag definition part of the MPV document, the information on the corresponding profile may be deleted.

According to another aspect of the present invention, there is provided an apparatus for reproducing multimedia data using a profile complying with an MPV standard, including: a profile manager which detects a reference element in an MPV document indicating that a predetermined profile among a plurality of supported profiles is used, and updates the MPV document using information on a profile corresponding to the detected reference element; and an MPV parser which reproduces multimedia data by parsing the updated MPV document.

### BRIEF DESCRIPTION OF THE DRAWINGS

The above and other aspects of the present invention will become more apparent by describing in detail exemplary embodiments thereof with reference to the attached drawings in which:

FIG. 1 is a diagram explaining the structure of multimedia data complying with MusicPhotoVideo (MPV) standard;

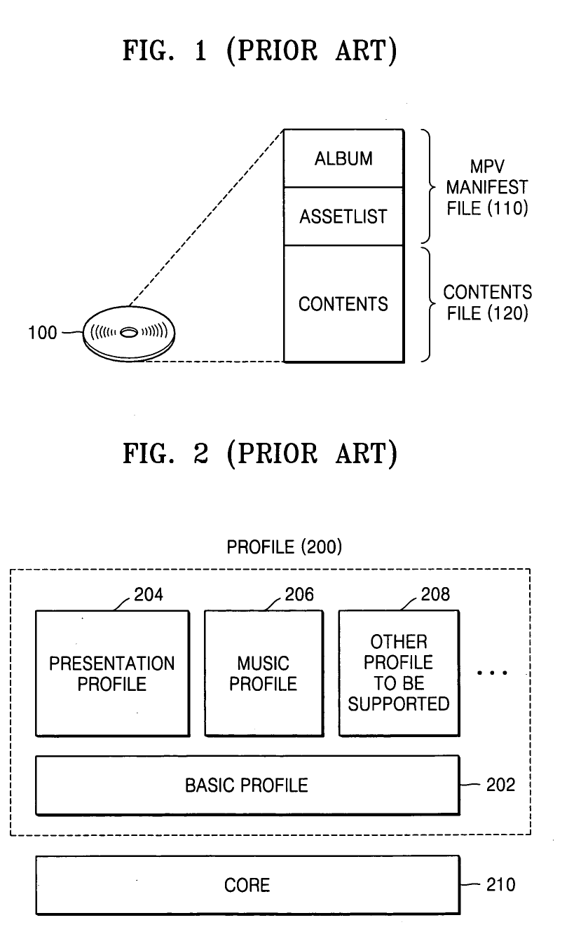

FIG. 2 is a diagram explaining a profile structure required for reproducing multimedia data complying with the MPV standard;

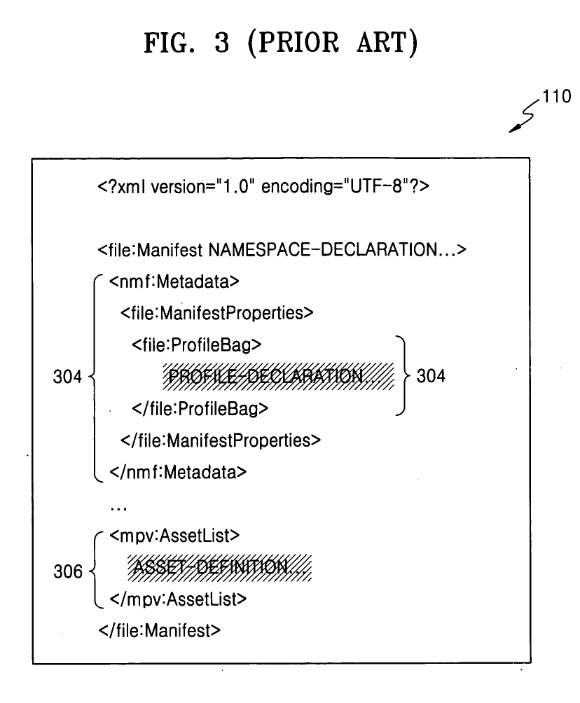

FIG. 3 is a diagram showing an example of a multimedia data file complying with the MPV standard;

FIG. 4 is a diagram showing the structure of an MPV document using a basic profile according to an exemplary embodiment of the present invention;

FIG. 5 is a diagram showing the structure of an MPV document using a presentation profile according to an exemplary embodiment of the present invention;

FIG. 6 is a block diagram of an apparatus for reproducing multimedia data complying with the MPV standard according to an exemplary embodiment of the present invention;

FIG. 7 is a diagram explaining a method to find a valid profile from an MPV document according to an exemplary embodiment of the present invention; and

FIGS. 8A and 8B are flowcharts illustrating a method to find a valid profile from an MPV document according to an exemplary embodiment of the present invention.

### DETAILED DESCRIPTION OF EXEMPLARY EMBODIMENTS OF THE INVENTION

Hereinafter, the present invention will be described in detail by explaining exemplary embodiments of the invention with reference to the attached drawings.

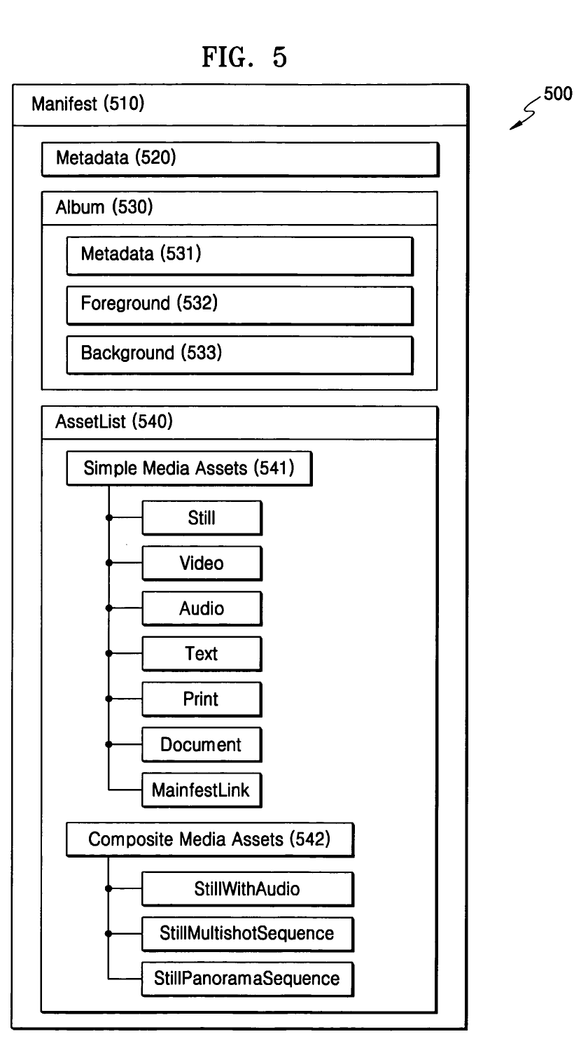

Referring to FIG. 4, an MPV document 400, that is, an MPV manifest file 410, includes metadata 420, which includes the definition of a basic profile, an AssetList 430, which defines the list of multimedia data, and MarkedAssets 440.

The AssetList 430 includes simple media assets 431 and composite media assets 432. The simple media assets 431 include digital photos (Still), video (Video), digital audio (Audio), digital text (Text), print (Print), document (Document), and manifest link (ManifestLink). The composite media assets 432 include digital photos+digital audio (StillWithAudio), digital still multi-shot sequences (StillMultishotSequence), panorama shot digital photos (StillPanaormaSequence).

Thus, in order to manage contents by using an MPV document containing the AssetList 430, the basic profile 202 is used. In particular, since the AssetList is basically included in all MPV files, the basic profile 202 is necessarily used.

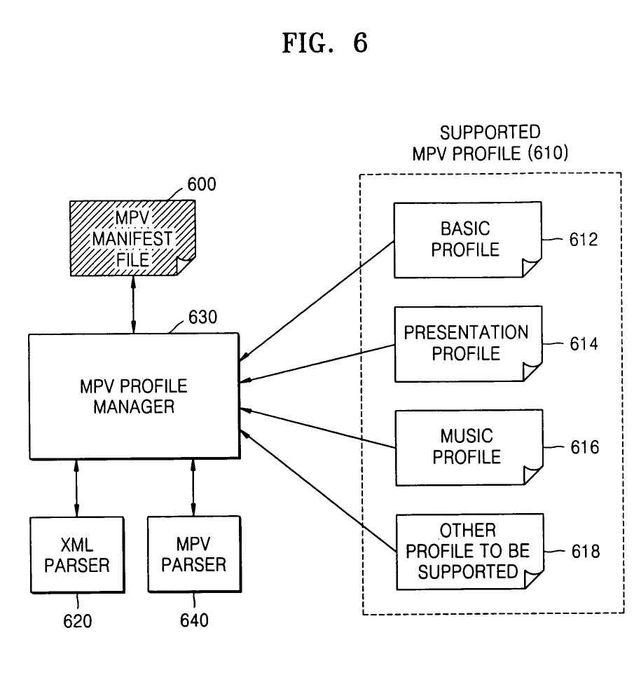

FIG. 5 is a diagram showing the structure of an MPV document using a presentation profile according to an exemplary embodiment of the present invention. Referring to FIG. 5, the MPV document 500 contains metadata 520 including a definition of a presentation profile, an AssetList 540 described above, and an album 530.

The album 530 includes a foreground asset 532 which expresses the asset of media appearing in the front when corresponding contents are reproduced, and a background asset 533 which expresses the asset of media used as a background when corresponding contents are reproduced. The AssetList 540 includes simple media assets 541 and composite media assets 542 as shown in FIG. 4.

Thus, in order to manage contents by using the MPV document containing the AssetList 540, the basic profile 202 is used and in order to reproduce contents by using the MPV document including the album 530, the presentation profile 204 is used.

Accordingly, by only confirming whether or not the AssetList element is included in an MPV document, it can be determined whether or not a basic profile is needed. Also, by only confirming whether or not an album element is included in an MPV document, it can be determined whether or not a presentation profile is needed. In the same manner, though not shown, it can be determined whether or not a music profile is needed, by only confirming whether or not music properties (MusicProperties) or audio+photos (AudioWithStills) elements are included in an MPV document. These elements have characteristics of being included only in the corresponding profiles.

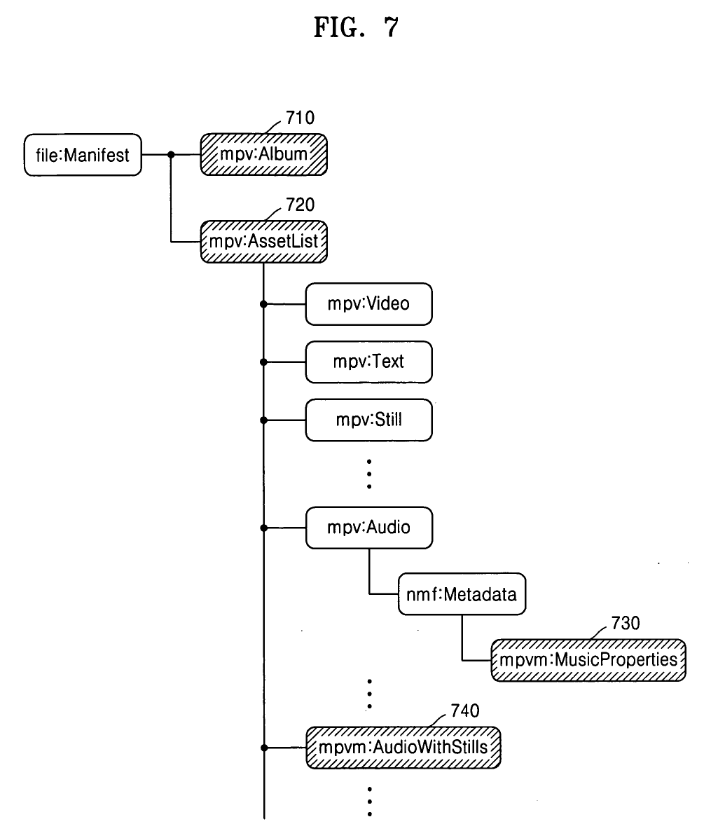

FIG. 6 is a block diagram of an apparatus for reproducing multimedia data complying with the MPV standard according to an exemplary embodiment of the present invention. Referring to FIG. 6, the contents reproducing apparatus according to the present invention includes an XML parser 620, an MPV profile manager 630, and an MPV parser 640.

The XML parser 620 parses an MPV document according to the XML rule. By using the parsing result of the XML parser 620, the MPV profile manager 630 determines whether or not there is a predetermined element capable of detecting a profile supported by the MPV parser 640. Also, by using the determined profile information, whether or not the ProfileBag corresponds with its contents is confirmed, and if a profile which is not detected among supported MPV profiles is included in the ProfileBag, the profile information is deleted from the ProfileBag. Also, detected profile information is added to the ProfileBag definition part. When there is no ProfileBag, a ProfileBag is newly generated and information on the detected profile is added.

The MPV parser 640 parses an MPV file by referring to the updated ProfileBag. Also, the MPV parser 640 supports a basic profile 612, a presentation profile 614, a music profile 616, and other profile 618 to be supported.

The operation of the exemplary reproducing apparatus according to the present invention will now be explained in more detail.

1) The MPV profile manager 630 transfers an MPV document to the XML parser 620.

2) The XML parser 620 parses the received MPV document according to the XML rule.

3) With the result parsed according to the XML rule in step 2), the MPV profile manager determines whether or not there is a predetermined element capable of detecting profiles supported by the MPV parser 640.

4) By using the determined profile information, the MPV profile manager 630 confirms whether the contents of the ProfileBag correspond with the information. If a profile which is not detected in step 3) among supported MPV profiles is included in the ProfileBag, the profile information is deleted in the ProfileBag. Also, information on the detected profile is added to the ProfileBag. If there is no ProfileBag, a ProfileBag is newly generated and information on the detected profile is added.

5) The MPV profile manager 630 stores the update result of the ProfileBag in a corresponding part of the MPV document.

6) The MPV profile manager 630 transfers the MPV document parsed according to the XML rule updated in step 5), to the MPV parser 640.

7) The MPV parser 640 parses the received MPV document. By using only the profile information included in the updated ProfileBag, the MPV parser can easily parse the MPV document.

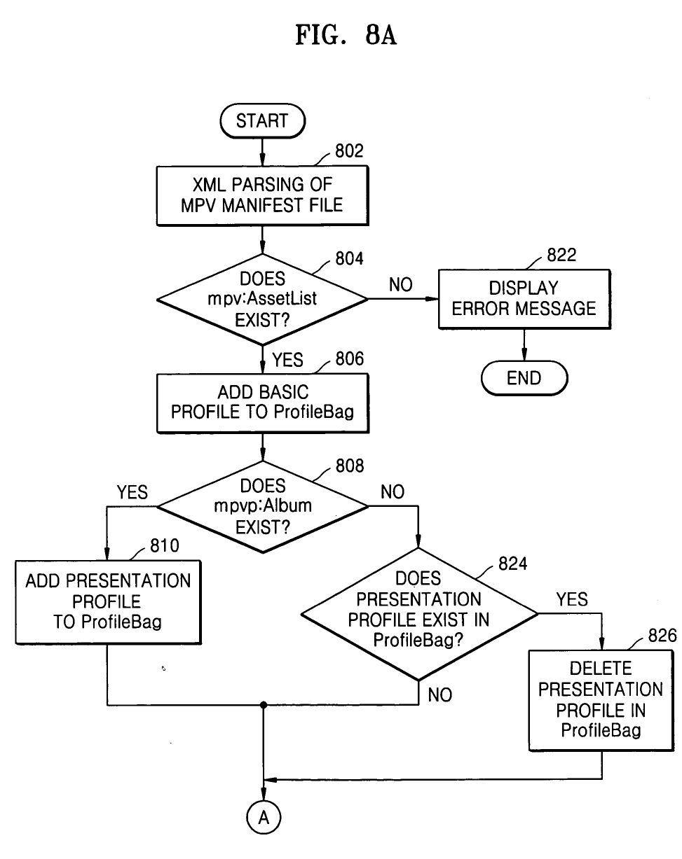

More specifically, FIG. 7 is a diagram explaining a method to find a valid profile from an MPV document according to an exemplary embodiment of the present invention. Referring to FIG. 7, all elements included in the MPV document are shown in a tree structure. In particular, those parts indicated by slanted lines are predetermined elements that are determination criteria for detecting profiles supported by the MPV parser. As described in FIG. 5, in detecting profiles supported by the MPV parser, by only confirming whether an AssetList 720 element is included in the MPV document, a basic profile can be detected. Also, by confirming whether or not an album 710 element is included, a presentation profile can be detected. By only confirming whether or not there is MusicProperties 730 defining below metadata (Metadata) below audio (Audio), or audio+photos (AudioWithStills) 740 element, a music profile can be detected. This is because these elements have characteristics of being included only in the corresponding profiles.

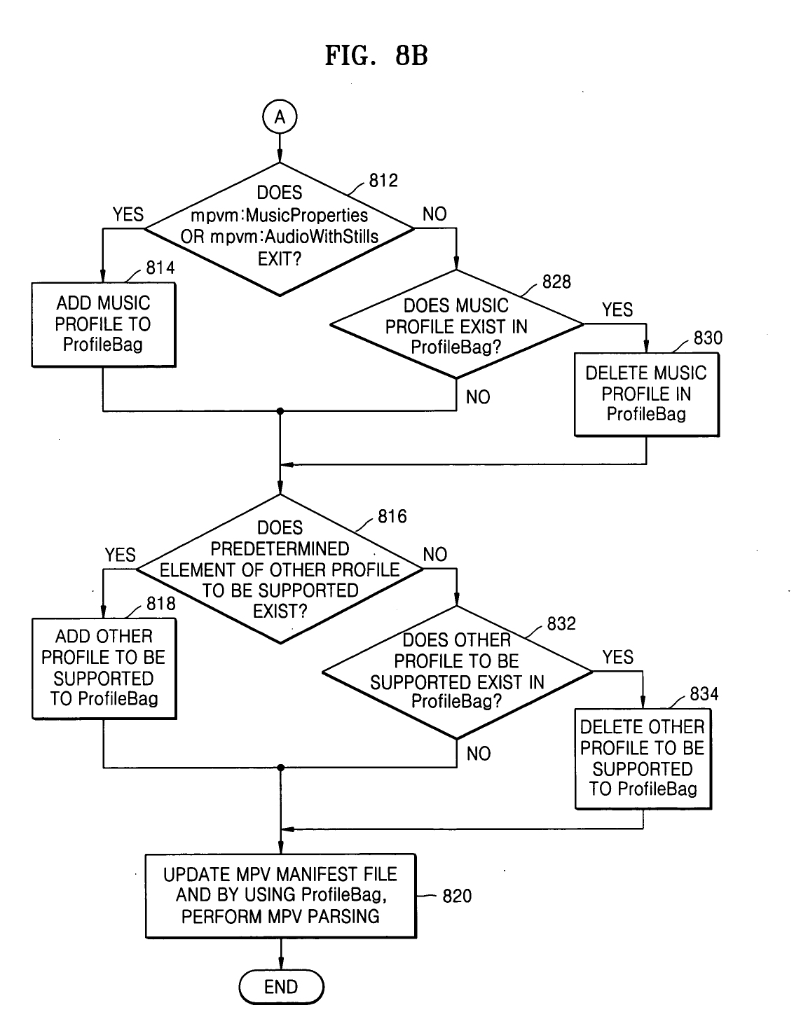

FIGS. 8A and 8B are flowcharts illustrating a method to find a valid profile from an MPV document according to an exemplary embodiment of the present invention. Referring to FIGS. 8A and 8B, by using the XML parser 620, an MPV document is parsed according to the XML rule in operation 802. The MPV profile manager 630 confirms whether there is mpv:AssetList that is an asset list element, in the MPV document parsed according to the XML rule in operation 804.

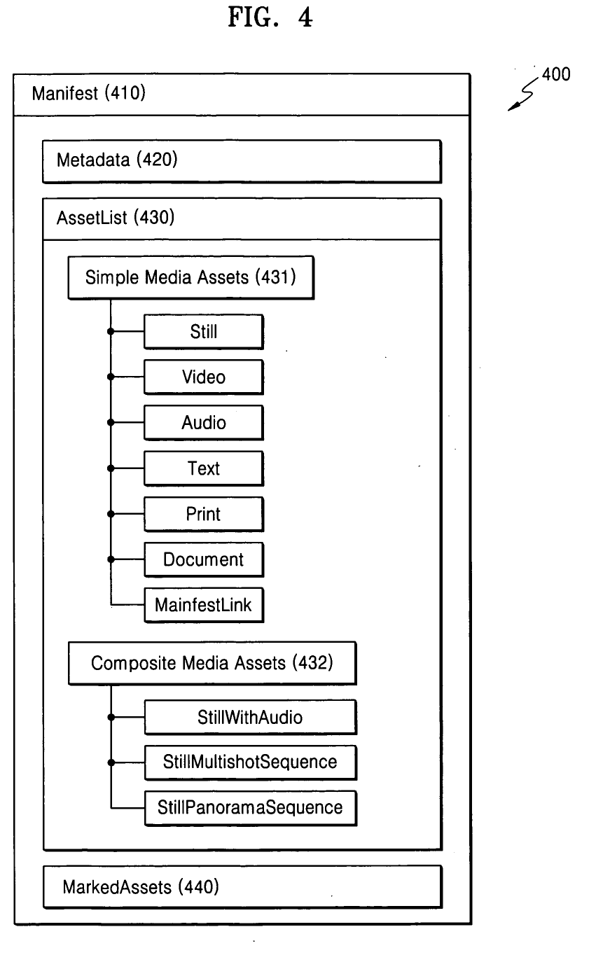

If there is the element, information on the basic profile 202 is added to the ProfileBag 304 of the MPV document shown in FIG. 3 in operation 806. If there is not, an error message indicating that the MPV document has an incorrect format is indicated in operation 822. This is because a basic profile should be included in an MPV document.

Also, the MPV profile manager 630 confirms whether there is mpvp:Album that is an album element, in the MPV document parsed according to the XML rule in operation 808. If there is the element, information on the presentation profile 204 is added to the ProfileBag 304 of the MPV document in operation 810. If there is not, it is confirmed whether information on the presentation profile is in the ProfileBag in operation 824, and the information is deleted from the ProfileBag in operation 826. This is because, if the album element is not actually included in the MPV document and the album element is in the ProfileBag, it means that the information of the ProfileBag 304 is invalid.

In addition, the MPV profile manager 630 confirms whether there is mpvm:MusicProperties that is a music property element, or mpvm:AudioWithStills that is an audio +digital photos element in the MPV document parsed according to the XML rule in operation 812. If there is, information on the music profile 206 is added to the ProfileBag of the MPV document in operation 814. If there is not, it is confirmed whether information on the music profile is in the ProfileBag in operation 828, and the information is deleted from the ProfileBag in operation 830. This is because, if the music element is not actually included in the MPV document and the music element is in the ProfileBag, it means that the information of the ProfileBag is invalid.

Also, the MPV profile manager 630 confirms whether or not there is a predetermined element of an other profile to be support, in the MPV document parsed according to the XML rule in operation 816, and if there is, information on the other profile 208 to be support is added to the ProfileBag 304 of the MPV document in operation 818. If there is not, it is confirmed whether or not information on the other profile to be support is in the ProfileBag in operation 832, and the information is deleted from the ProfileBag in operation 834.

Finally, the MPV profile manager 630 updates the ProfileBag 304 part of the MPV document, and the MPV parser 640 parses the MPV document by using the updated ProfileBag in operation 820.

The present invention can be applied to products complying with the MPV standard, and to customer electronics (CE) products in particular. For example, the products can include multimedia contents reproducing apparatuses such as a PC, a DVD player, a DVD recorder with a DVD reproduction function, and an MP3 player.

While the present invention has been particularly shown and described with reference to exemplary embodiments thereof, it will be understood by those of ordinary skill in the art that various changes in form and details may be made therein without departing from the spirit and scope of the present invention as defined by the following claims.

According to an exemplary embodiment of the present invention as described above, a method for reproducing multimedia data by which profiles used in an MPV file are not determined every time multimedia data is reproduced, and a method in which multimedia data is reproduced by efficiently using an MPV standard profile, and a reproducing apparatus thereof are provided.

Also, the present invention provides a method capable of detecting information on a profile actually used in an MPV document even when a ProfileBag is not included in an MPV document, or when the contents of the ProfileBag do not correspond with the contents of the actual MPV document.

Furthermore, by comparing predetermined elements in respective profiles, the speed of parsing an MPV document increases. Also, by putting a verification process for the contents of the ProfileBag included in an MPV document, incorrect loading of unnecessary profiles actually not used is prevented such that resources are saved.

Even when an MPV file verified according to the present invention is reproduced later in another contents reproducing apparatus, data can be reproduced by using only information on the profile specified in the verified ProfileBag. Accordingly the reproduction speed increases and the resources are saved.

1. A method for reproducing multimedia data using a profile complying with a MusicPhotoVideo (MPV) standard, the method comprising:
detecting a reference element, in an MPV document, indicating that a predetermined profile among a plurality of supported profiles is used;
updating the MPV document using information on a profile corresponding to the reference element which is detected; and
reproducing multimedia data by parsing the MPV document which is updated.

2. The method of claim 1, wherein the plurality of supported profiles include at least one of a basic profile which defines an asset list, a presentation profile which defines a method of displaying multimedia data, a music profile which defines a music related file, and a spare profile to be supported.

3. The method of claim 2, wherein the reference element is an asset list (AssetList) element in the case of the basic profile, an album (Album) element in a case of the presentation profile, and a music properties (MusicProperties) element or audio+digital photo (AudioWithStill) element in a case of the music profile.

4. The method of claim 1, wherein in updating the MPV document, the information on the profile corresponding to the reference element which is detected is added to a ProfileBag definition part of the MPV document.

5. The method of claim 4, wherein in updating the MPV document, if a reference element is not detected and information on a profile corresponding to a reference element is in the ProfileBag part of the MPV document, the information on the profile corresponding to the reference element is deleted.

6. An apparatus for reproducing multimedia data using a profile complying with an MPV standard, the apparatus comprising:
a profile manager which detects a reference element in an MPV document indicating that a predetermined profile among a plurality of supported profiles is used, and updates the MPV document using information on a profile corresponding to the reference element which is detected; and
an MPV parser which reproduces multimedia data by parsing the MPV document which is updated.

7. The apparatus of claim 6, wherein the plurality of supported profiles include at least one of a basic profile which defines an asset list, a presentation profile which defines a method of displaying multimedia data, a music profile which defines a music related file, and a spare profile to be supported.

8. The apparatus of claim 7, wherein the reference element is an asset list (AssetList) element in a case of the basic profile, an album (Album) element in a case of the presentation profile, a music properties (MusicProperties) element or audio+digital photo (AudioWithStill) element in the case of the music profile.

9. The apparatus of claim 6, wherein the profile manager adds information on a profile corresponding to the reference element which is detected to ProfileBag definition part of the MPV document.

10. The apparatus of claim 9, wherein if the reference element is not detected and information on a profile corresponding to the reference element is in the ProfileBag definition part of the MPV document, the profile manager deletes the information on the profile corresponding to the reference element.

11. The apparatus of claim 6, wherein the apparatus comprises a personal computer, a DVD player, a DVD recorder with a DVD reproduction function, or an MP3 player.

12. A method for reproducing multimedia data using a profile complying with a MusicPhotoVideo (MPV) standard, the method comprising:
detecting a reference element, in an MPV file, indicating that a predetermined profile among a plurality of supported profiles is used;
determining profiles to be used in the MPV file using information on a profile corresponding to the reference element which is detected; and
reproducing multimedia data by using the profiles which are determined.
